(19) United States
(12) Patent Application Publication
(10) Pub. No.: US 2018/0017821 A1
(43) Pub. Date: Jan. 18, 2018

(54) LIQUID CRYSTAL DISPLAY DEVICE WITH TOUCH SENSOR

(71) Applicant: SHARP KABUSHIKI KAISHA, Sakai City, Osaka (JP)

(72) Inventors: SHINICHI MIYAZAKI, Sakai City (JP); MIKIHIRO NOMA, Sakai City (JP); MASAHIRO OKUNO, Sakai City (JP); MASASHI MAYUMI, Sakai City (JP)

(21) Appl. No.: 15/552,794

(22) PCT Filed: Feb. 22, 2016
(86) PCT No.: PCT/JP2016/055047

§ 371 Date: Aug. 22, 2017

(30) Foreign Application Priority Data
Feb. 24, 2015 (JP) 2015-033444

(51) Int. Cl. G02F 1/1333; G06F 3/041; G02F 1/1335; G06F 3/044

(52) U.S. Cl. CPC G02F 1/13338; G06F 3/044; G06F 3/0416; G02F 1/133528; G06F 3/0412; G02F 2202/16

(57) ABSTRACT

Provided is a liquid crystal display device with a touch sensor in which abnormal alignment of liquid crystal molecules of a liquid crystal layer is hardly generated even when charged bodies get closer to the liquid crystal display device. The liquid crystal display device with a touch sensor includes a liquid crystal layer 13 interposed between a CF substrate 11 (a first substrate) and an array substrate 12 (a second substrate), in which at least one electrode of touch drive electrodes 14 and touch detection electrodes 15 is disposed on a surface of a front side of the CF substrate 11 and a polarizing plate 17 is further disposed on the electrode. On the surface of the front side of the CF substrate 11, dummy electrodes 16 are disposed in a region where neither the touch drive electrodes 14 nor the touch detection electrodes 15 are arranged. The polarizing plate 17 includes a conductive layer having a surface resistance of 10⁹ (Ω/□) or more and 10¹⁰ (Ω/□) or less.

### TECHNICAL FIELD

The present invention relates to a liquid crystal display device with a touch sensor.

### BACKGROUND ART

PTL 1 discloses a liquid crystal display device with a touch sensor, which has a liquid crystal layer between a TFT substrate and a glass substrate that are opposite to each other and includes touch detection electrodes on a surface of a front side of the glass substrate and touch drive electrodes between the glass substrate and the TFT substrate. The liquid crystal display device with a touch sensor includes pixel electrodes and common electrodes between the liquid crystal layer and the TFT substrate in order to control image display.

### CITATION LIST

### Patent Literature

PTL 1: Japanese Unexamined Patent Application Publication No. 2014-219986

### SUMMARY OF INVENTION

### Technical Problem

Here, when electrically charged bodies get closer to a surface of the liquid crystal display device with a touch sensor, a vertical electric field is generated between the charged bodies and the common electrodes and liquid crystal molecules of the liquid crystal layer are aligned abnormally, so that there is a possibility that an image is not displayed normally.

An object of the invention is to provide a liquid crystal display device with a touch sensor capable of suppressing abnormal alignment of liquid crystal molecules of a liquid crystal layer even when charged bodies get closer.

### Solution to Problem

A liquid crystal display device with a touch sensor in an embodiment of the invention includes: a first substrate; a second substrate that is opposite to the first substrate; a liquid crystal layer interposed between the first substrate and the second substrate; a touch sensor that includes a plurality of touch drive electrodes and a plurality of touch detection electrodes that are arranged such that at least one electrode of the touch drive electrodes and the touch detection electrodes is disposed on a first surface of the first substrate, which is opposite to the liquid crystal layer; dummy electrodes disposed in a region where neither the touch drive electrodes nor the touch detection electrodes are disposed on the first surface of the first substrate; and a polarizing plate that is disposed on electrodes that are arranged on the first surface of the first substrate, of the touch drive electrodes and the touch detection electrodes and that includes a conductive layer having a surface resistance of 10⁹ (Ω/□: ohms per square) or more and 10¹⁰ (Ω/□) or less.

### Advantageous Effects of Invention

According to the invention, the surface resistance of the conductive layer included in the polarizing plate is set to be 10⁹ (Ω/□) or more and 10¹⁰ (Ω/□) or less. Thereby, even when charged bodies get closer to a surface of the liquid crystal display device with a touch sensor, electric charges move from the dummy electrodes via the polarizing plate, so that a vertical electric field is hardly generated and abnormal alignment of liquid crystal molecules of the liquid crystal layer may be suppressed.

### BRIEF DESCRIPTION OF DRAWINGS

FIG. 1 is a plan view of a liquid crystal display device with a touch sensor in a first embodiment.

FIG. 2 is an enlarged view of a part surrounded by a dotted line of FIG. 1.

FIG. 3 is a cross-sectional view taken along a line II-II of FIG. 2.

FIG. 4 is a cross-sectional view illustrating a structure of a polarizing plate.

FIG. 5 is a cross-sectional view illustrating another structure of the polarizing plate.

FIG. 6 is a plan view of a liquid crystal display device with a touch sensor in a second embodiment.

FIG. 7 is an enlarged view of a part surrounded by a dotted line of FIG. 6.

FIG. 8 is a cross-sectional view taken along a line VIII-VIII of FIG. 7.

FIG. 9 is a schematic view illustrating a method of measuring surface resistance of a conductive layer.

### DESCRIPTION OF EMBODIMENTS

A liquid crystal display device with a touch sensor in an embodiment of the invention includes: a first substrate; a second substrate that is opposite to the first substrate; a liquid crystal layer interposed between the first substrate and the second substrate; a touch sensor that includes a plurality of touch drive electrodes and a plurality of touch detection electrodes that are arranged such that at least one electrode of the touch drive electrodes and the touch detection electrodes is disposed on a first surface of the first substrate, which is opposite to the liquid crystal layer; dummy electrodes disposed in a region where neither the touch drive electrodes nor the touch detection electrodes are disposed on the first surface of the first substrate; and a polarizing plate that is disposed on electrodes that are arranged on the first surface of the substrate, of the touch drive electrodes and the touch detection electrodes and that includes a conductive layer having a surface resistance of 10⁹ (Ω/□) or more and 10¹⁰ (Ω/□) or less (first configuration).

According to the first configuration, even when charged bodies get closer to a surface of the liquid crystal display device with a touch sensor, electric charges move from the dummy electrodes via the polarizing plate, so that a vertical electric field is hardly generated, and abnormal alignment of liquid crystal molecules of the liquid crystal layer may be suppressed.

In the first configuration, it may be configured such that the polarizing plate includes: a polarizer; the conductive layer having a surface resistance of 10⁹ (Ω/□) or more and 10¹⁰ (Ω/□) or less; and an adhesive layer for bonding the polarizing plate to the electrodes that are arranged on the first surface of the first substrate, of the touch drive electrodes and touch detection electrodes (second configuration).

According to the second configuration, the conductive layer having a surface resistance of 10⁹ (Ω/□) or more and 10¹⁰ (Ω/□) or less is provided in the polarizing plate, so that abnormal alignment of liquid crystal molecules of the liquid crystal layer may be suppressed when charged bodies get closer to the surface of the liquid crystal display device with a touch sensor.

In the first configuration, it may be configured such that the polarizing plate includes a polarizer and the conductive layer having a surface resistance of 10⁹ (Ω/□) or more and 10¹⁰ (Ω/□) or less, and the conductive layer includes an adhesive member for bonding the polarizing plate to the electrodes that are arranged on the first surface of the first substrate, of the touch drive electrodes and the touch detection electrodes (third configuration).

According to the third configuration, the surface resistance of the conductive layer that also functions as an adhesive layer is set to be 10⁹ (Ω/□) or more and 10¹⁰ (Ω/□) or less, so that abnormal alignment of liquid crystal molecules of the liquid crystal layer may be suppressed when charged bodies get closer to the surface of the liquid crystal display device with a touch sensor.

In any of the first to third configurations, it may be configured such that the touch drive electrodes and the touch detection electrodes are disposed on the first surface of the first substrate (fourth configuration).

According to the fourth configuration, abnormal alignment of liquid crystal molecules of the liquid crystal layer may be suppressed when charged bodies get closer to a liquid crystal display device with a touch sensor that has a so-called on-cell structure.

In any of the first to third configurations, it may be configured such that the touch detection electrodes are disposed on the first surface of the first substrate, and the touch drive electrodes are disposed between the first substrate and the second substrate (fifth configuration).

According to fifth configuration, abnormal alignment of liquid crystal molecules of the liquid crystal layer may be suppressed when charged bodies get closer to a liquid crystal display device with a touch sensor that has a so-called semi in-cell structure.

### EMBODIMENTS

Hereinafter, embodiments of the invention will be described in detail with reference to drawings. The same reference signs are assigned to the same portions or the corresponding portions throughout drawings, and description thereof will not be repeated. Note that, in order to facilitate understanding of description, in drawings that are used for reference below, there is a case where a configuration is simplified or schematically illustrated or a part of component members is omitted. Additionally, size ratios of the components illustrated in the drawings do not necessarily represent actual size ratios.

### First Embodiment

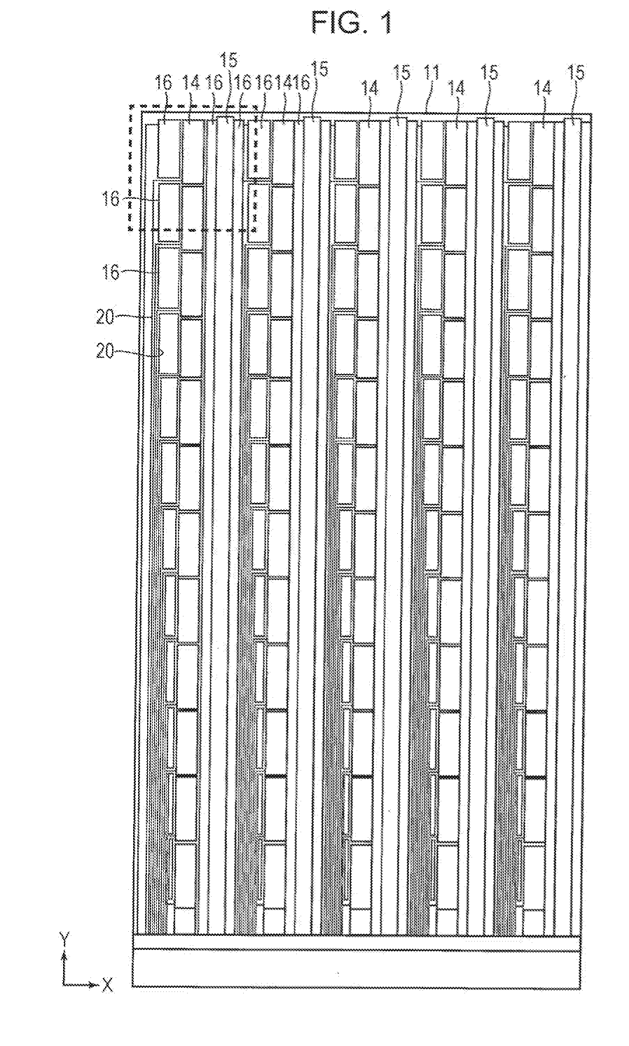

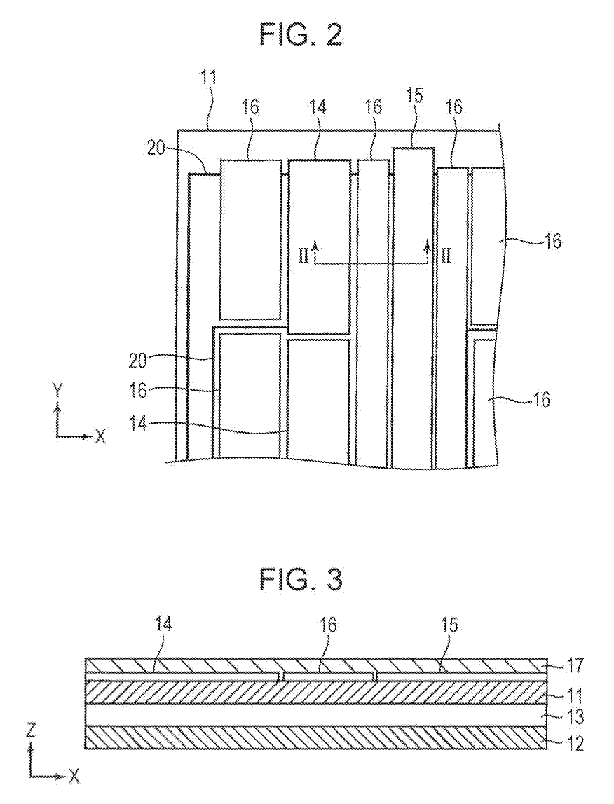

FIG. 1 is a plan view of a liquid crystal display device with a touch sensor according to a first embodiment. FIG. 2 is an enlarged view of a part surrounded by a dotted line of FIG. 1. FIG. 3 is a cross-sectional view taken along a line II-II of FIG. 2.

The liquid crystal display device with a touch sensor in the first embodiment includes a pair of transparent substrates (with excellent transparency) 11 and 12, a liquid crystal layer 13 interposed between the substrates 11 and 12, touch drive electrodes 14, touch detection electrodes 15, dummy electrodes 16, and a polarizing plate 17.

Each of the substrates 11 and 12 that are opposite to each other includes a substantially transparent glass substrate, and has a configuration in which a plurality of layers are laminated on the glass substrate by a known photolithography method or the like. In the substrates 11 and 12, the substrate on a front side (a front side of the liquid crystal display device) is a CF substrate (a first substrate) 11, and the substrate on a rear side (a back side of the liquid crystal display device) is an array substrate (a second substrate) 12.

The liquid crystal layer 13 includes liquid crystal molecules that are material having optical characteristics which are changed with application of an electric field. The liquid crystal molecules are, for example, positive liquid crystal molecules and are driven by a horizontal electric field driving system such as an IPS system. Note that, an alignment layer (not illustrated) for aligning the liquid crystal molecules that are included in the liquid crystal layer 13 is formed on each of inner sides of the substrates 11 and 12. Although not illustrated, a plurality of TFTs (Thin Film Transistors) serving as switching elements and a plurality of pixel electrodes are provided in a matrix on an inner side (the liquid crystal layer 13 side) of the array substrate 12. Additionally, common electrodes are provided between the pixel electrodes and the liquid crystal layer 13 via an insulation layer.

On the other hand, a color filter (not illustrated) arranged in a matrix is provided on the CF substrate 11 such that colored parts of R (red), G (green), B (blue), and the like overlap the pixel electrodes on the array substrate 12 side in a plan view. A light shielding layer (black matrix) in a substantially lattice shape for preventing color mixture is formed for the color filter having the colored parts.

In the liquid crystal display device with a touch sensor, a pixel, which serves as a unit region for display, is constituted by a combination of three colored parts and three pixel electrodes that are opposite to the three colors of R (red), G (green), and B (blue), respectively. The pixel is formed of a red sub-pixel having the colored part of R, a green sub-pixel having the colored part of G, and a blue sub-pixel having the colored part of B. The sub-pixels of the respective colors are repeatedly arranged along a row direction (X-axis direction) and thereby constitute a group of pixels, and the group of pixels is arranged along a column direction (Y-axis direction). That is, a plurality of pixel groups are arranged in a matrix. In the present embodiment, the sub-pixels are arranged in a so-called stripe arrangement.

The touch drive electrodes 14, the touch detection electrodes 15, and the dummy electrodes 16 are provided on a surface (a first surface) of a front side of the CF substrate 11. That is, the liquid crystal display device with a touch sensor in the present embodiment has a so-called on-cell structure in which the touch drive electrodes 14 and the touch detection electrodes 15 are provided on a surface of the outside (front side) of the CF substrate 11.

A touch sensor that detects a touch position is constituted by the touch drive electrodes 14 and the touch detection electrodes 15. The touch sensor adopts a so-called projection-capacitive system, and uses a mutual capacitive system as a detection system. The touch drive electrodes 14 and the touch detection electrodes 15 are constituted by a conductive layer that is made of a material, such as ITO (Indium Tin Oxide) or ZnO (Zinc Oxide), having excellent transparency and conductivity.

As illustrated FIG. 1, a plurality of touch drive electrodes 14 are arranged in one row in the Y-axis direction, and a plurality of rows of the touch drive electrodes 14 arranged in the Y-axis direction are arranged in the X-axis direction at a predetermined interval.

As illustrated in FIG. 1, the touch detection electrodes 15 extend in the Y-axis direction, and a plurality of touch detection electrodes 15 each extending in the Y-axis direction are arranged in the X-axis direction at a predetermined interval.

Signals for detecting a touch position are supplied through wires 20 to the plurality of touch drive electrodes 14. When a touch position is detected, the signals are input to the plurality of touch drive electrodes 14 while sequentially scanning the touch drive electrodes 14, and output signals output from the respective touch detection electrodes 15 are detected. When any position of the surface of the liquid crystal display device with a touch sensor is touched, capacitance, at the touched position, between a corresponding electrode of the touch drive electrodes 14 and a corresponding electrode of the touch detection electrodes 15 is changed. On the basis of the output signals output from the touch detection electrodes 15, the position at which capacitance is changed is detected, and the detected position is specified as a touch position.

On the surface of the front side of the CF substrate 11, the dummy electrodes 16 are provided in a region other than regions where the touch drive electrodes 14, the touch detection electrodes 15, and the wires 20 are provided. The dummy electrodes 16 are provided on the front side of the CF substrate 11 to prevent occurrence of variation between a transmittance at a position where the touch drive electrodes 14 and the touch detection electrodes 15 are provided and a transmittance at a position where neither the touch drive electrodes 14 nor the touch detection electrodes 15 are provided. Accordingly, the dummy electrodes 16 are also constituted by the conductive layer made of a similar material to those of the touch drive electrodes 14 and the touch detection electrodes 15, that is, a material, such as ITO or ZnO, having excellent transparency. Note that, the dummy electrodes 16 are not connected to other wires or electrodes, that is, are used in an electrically floating state.

The polarizing plate 17 is provided on the touch drive electrodes 14, the touch detection electrodes 15, and the dummy electrodes 16.

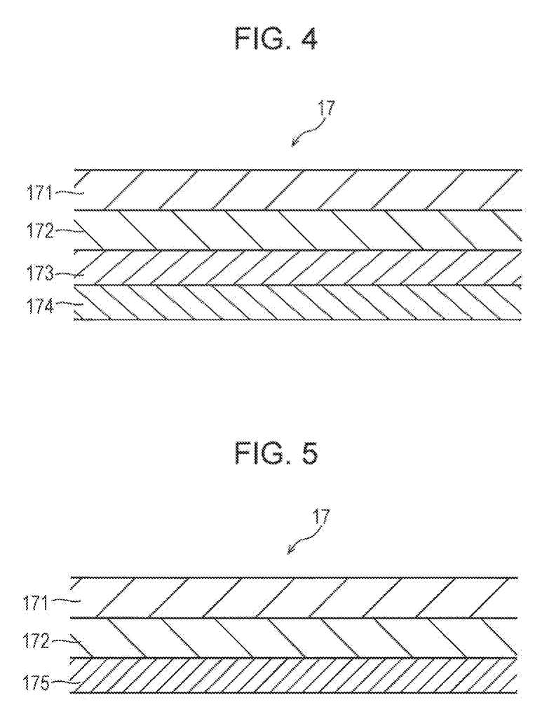

FIG. 4 is a cross-sectional view illustrating a structure of the polarizing plate 17. The polarizing plate 17 includes a hard coat layer 171 that is a protection layer, a polarizer 172, a conductive layer 173, and an adhesive layer 174. The adhesive layer 174 is a layer for bonding the touch drive electrodes 14, the touch detection electrodes 15 and the dummy electrodes 16 to the polarizing plate 17.

The conductive layer 173 is made of conductive resin including, for example, a conductive material. In the present embodiment, a surface resistance of the conductive layer 173 is 10⁹ (Ω/□: ohms per square) or more and 10¹⁰ (Ω/□) or less.

As described above, when charged bodies get closer to a surface of the liquid crystal display device with a touch sensor, a vertical electric field is generated between the charged bodies and common electrodes via dummy electrodes, and abnormal alignment of liquid crystal molecules of a liquid crystal layer occurs, so that an image may not be normally displayed. However, as a result of conducting an experiment by changing surface resistance of the conductive layer included in the polarizing plate, an inventor found that in a case where the surface resistance of the conductive layer was 10⁹ (Ω/□) or more and 10¹⁰ (Ω/□) or less, even when the charged bodies were brought near to the surface of the liquid crystal display device with a touch sensor, electric charges moved from the dummy electrodes 16 to the touch drive electrodes 14 and the touch detection electrodes 15 via the polarizing plate 17, so that a vertical electric field was hardly generated and abnormal alignment of liquid crystal molecules of the liquid crystal layer 13 was suppressed.

On the other hand, when the surface resistance of the conductive layer was more than 10¹⁰ (Ω/□), conductivity was insufficient and abnormal alignment of the liquid crystal molecules of the liquid crystal layer 13 occurred when the charged bodies were brought near. Additionally, when the surface resistance of the conductive layer was less than 10⁹ (Ω/□), capacitive coupling was generated between the polarizing plate 17 and the touch detection electrodes 15, and touch detection accuracy of a touch sensor was deteriorated.

For the reasons described above, in the present embodiment, the surface resistance of the conductive layer 173 of the polarizing plate 17 is set to be 10⁹ (Ω/□) or more and 10¹⁰ (Ω/□) or less. Note that, no matter what resistivity value the conductive material has, it is possible that the surface resistance of the conductive layer 173 is set to be 10⁹ (Ω/□) or more and 10¹⁰ (Ω/□) or less by adjusting film thickness of the conductive layer 173.

FIG. 5 is a cross-sectional view illustrating another structure of the polarizing plate 17. The polarizing plate 17 illustrated in FIG. 5 includes the hard coat layer 171 that is a protection layer, the polarizer 172, and a conductive layer 175.

For the reasons described above, a surface resistance of the conductive layer 175 is 10⁹ (Ω/□) or more and 10¹⁰ (Ω/□) or less. The conductive layer 175 also functions as an adhesive layer including adhesive material for bonding the touch drive electrodes 14, the touch detection electrodes 15, and the dummy electrodes 16 to the polarizing plate 17.

### Second Embodiment

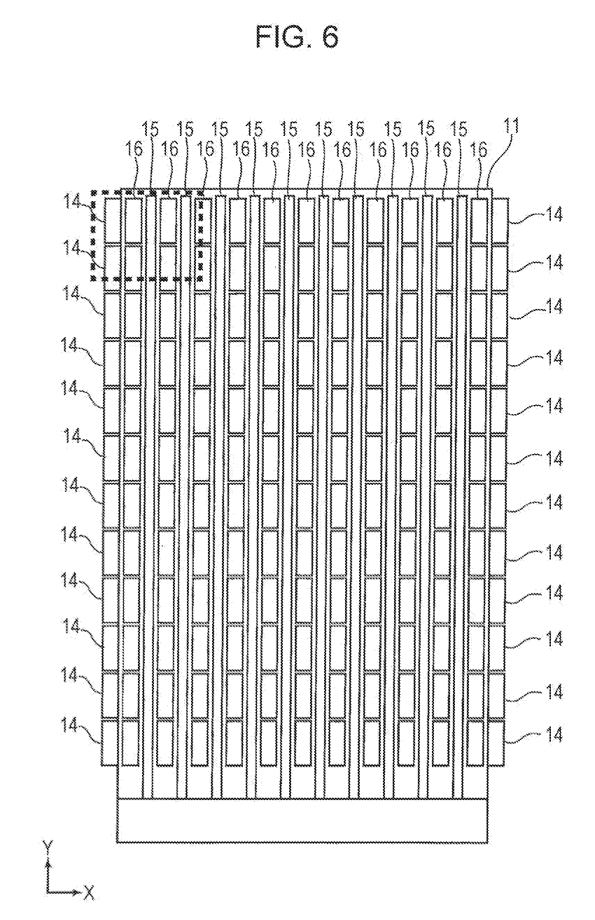

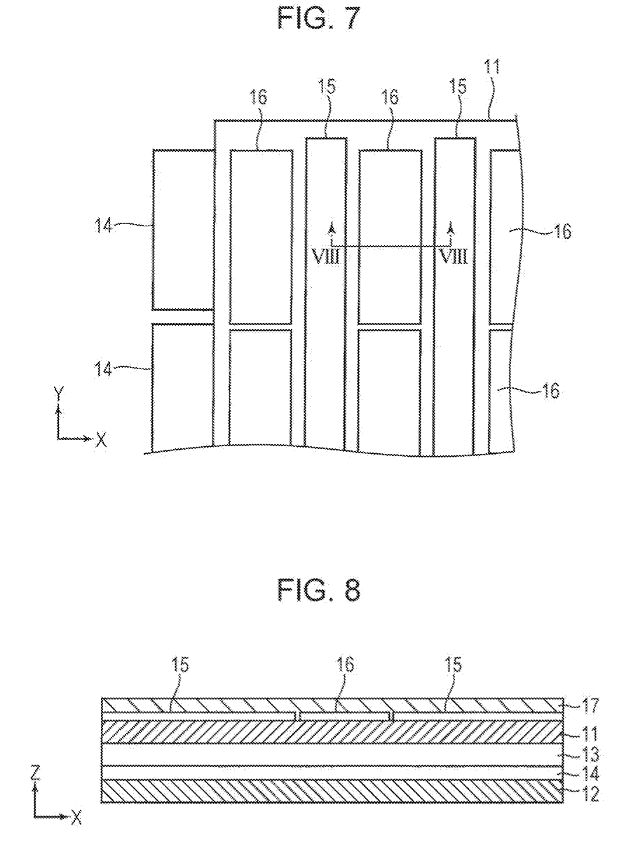

FIG. 6 is a plan view of a liquid crystal display device with a touch sensor in a second embodiment. FIG. 7 is an enlarged view of a part surrounded by a dotted line of FIG. 6. FIG. 8 is a cross-sectional view taken along a line VIII-VIII of FIG. 7. Note that, among components of the liquid crystal display device with a touch sensor illustrated in FIGS. 6 to 8, the same reference signs are assigned to the same components as those of the liquid crystal display device with a touch sensor illustrated in FIGS. 1 to 3, and detailed description thereof will be omitted.

The liquid crystal display device with a touch sensor in the second embodiment is different from the liquid crystal display device with a touch sensor in the first embodiment in a layout of the touch drive electrodes 14, the touch detection electrodes 15, and the dummy electrodes 16.

As illustrated in FIG. 6, each of the touch drive electrodes 14 extends in the X-axis direction, and a plurality of touch drive electrodes 14 are arranged in the Y-axis direction at a predetermined interval. As illustrated in FIG. 8, the touch drive electrodes 14 are arranged between the array substrate 12 and the liquid crystal layer 14.

Note that, common electrodes arranged between the array substrate 12 and the liquid crystal layer 14 may be commonly used as the touch drive electrodes 14.

As illustrated in FIG. 6, each of the touch detection electrodes 15 extends in the Y-axis direction, and a plurality of touch detection electrodes 15 are arranged in the X-axis direction at a predetermined interval. As illustrated in FIG. 8, the touch detection electrodes 15 are arranged on the front side of the CF substrate 11.

That is, the liquid crystal display device with a touch sensor of the present embodiment has a so-called semi in-cell structure in which the touch detection electrodes 15 are provided on the outside (front side) of the CF substrate 11 and the touch drive electrodes 14 are provided on the inner side (rear side) of the CF substrate 11.

The dummy electrodes 16 are provided in a region where the touch detection electrodes 15 are not provided on the front side of the CF substrate 11. Note that, when each of the dummy electrodes 16 is provided to be over a plurality of touch drive electrodes 14, since interference of signals supplied to the touch drive electrodes 14 may possibly be caused via the dummy electrodes 16, each of the dummy electrodes 16 is divided such that one dummy electrode is not provided over a plurality of (at least two) touch drive electrodes 14.

The polarizing plate 17 is provided on the touch detection electrodes 15 and the dummy electrodes 16. For the reasons described above, the polarizing plate 17 includes the conductive layer having a surface resistance of 10⁹ (Ω/□) or more and 10¹⁰ (Ω/□) or less. The polarizing plate 17 may have the configuration illustrated in FIG. 4 or the configuration illustrated in FIG. 5. Also in the liquid crystal display device with a touch sensor in the second embodiment, electric charges move from the dummy electrodes 16 to the touch detection electrodes 15 via polarizing plate 17 even when the charged bodies get closer, so that a vertical electric field is hardly generated and abnormal alignment of liquid crystal molecules of the liquid crystal layer 13 is suppressed.

### Modified Example

The invention is not limited to the embodiments described above. For example, the configuration of the polarizing plate 17 is not limited to the configuration illustrated in FIG. 4 or the configuration illustrated in FIG. 5, and may be a configuration that has a conductive layer having a surface resistance of 10⁹ (Ω/□) or more and 10¹⁰ (Ω/□) or less. Accordingly, in the configuration illustrated in FIG. 4, the conductive layer 173 may be provided on the hard coat layer 171 or may be provided between the hard coat layer 171 and the polarizer 172. Additionally, in the configuration of FIG. 4, it may be configured such that, without providing the conductive layer 173, a conductive layer is formed by including the hard coat layer 171 or the polarizer 172 which includes the conductive material such that the surface resistance of the conductive layer is 10⁹ (Ω/□) or more and 10¹⁰ (Ω/□) or less. Additionally, in the configuration of FIG. 5, it may be configured such that the conductive layer 175 is used simply as an adhesive layer, and a conductive layer is formed by including the hard coat layer 171 or the polarizer 172 which includes the conductive material such that the surface resistance of the conductive layer is 10⁹ (Ω/□) or more and 10¹⁰ (Ω/□) or less.

Note that, a value of the surface resistance of the conductive layer of the polarizing plate 17 is able to be obtained as follows in any of the aforementioned configurations of the first embodiment, the second embodiment, and the modified example.

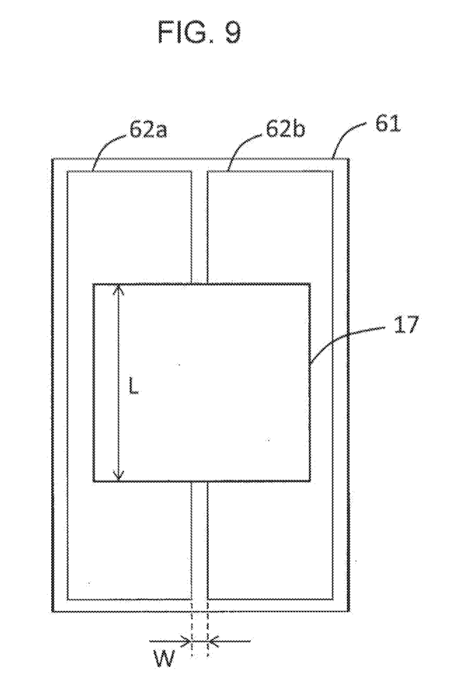

As illustrated in FIG. 9, two ITO patterns 62a and 62b which have the same size are formed on the surface of the glass substrate 61 with providing W as a predetermined interval. Here, the predetermined interval W is set as 13 μm. The polarizing plate 17 including the conductive layer is stuck so as to be over the ITO patterns 62a and 62b, and resistance R_{ab} (MΩ) between the ITO patterns 62a and 62b is measured. At this time, in the case of having the configuration illustrated in FIG. 4, the polarizing plate 17 is stuck to the ITO patterns 62a and 62b by the adhesive layer 174. Additionally, in the case of having the configuration illustrated in FIG. 5, the polarizing plate 17 is stuck to the ITO patterns 62a and 62b by the conductive layer 175 having adhesiveness.

Note that, ionic material is generally used for applying conductivity to the conductive layer, so that a measured value of the resistance R_{ab} is gradually increased. Accordingly, it is desired that measurement of the resistance R_{ab} is immediately performed. In this case, a measurement time is set to be about 1 second.

In a case where width of the polarizing plate 17 is L μm, surface resistance R_{sq} (Ω/□) of the conductive layer of the polarizing plate 17 is able to be obtained by

R_{sq}=R_{ab}×L/W.

For example, in a case where the polarizing plate 17 in which X=60000 μm is to be measured, when the measured value of R_{ab} is 21.5 MΩ, the surface resistance R_{sq} (Ω/□) of the conductive layer of the polarizing plate 17 is

$$\begin{matrix}{R}_{sq} = 21.5 \times {10}^{6} \times 60000 / 13 \\ \approx 99230769230.77 \\ \approx 9.92 \times {10}^{10} [ Ω / • ] .\end{matrix}$$

Note that, though members (for example, in the first embodiment, the hard coat layer 171, the polarizer 172, and the adhesive layer 174) other than the conductive layer are included in the polarizing plate 17, the members do not have conductivity and hence do not affect the value of the surface resistance of the conductive layer. Accordingly, the surface resistance of the conductive layer of the polarizing plate 17 is able to be measured by setting the entire polarizing plate 17 as a measured object without detaching the conductive layer from the polarizing plate 17. In other words, it is possible to express that the liquid crystal display device with a touch sensor according to the invention includes a polarizing plate having a surface resistance of 10⁹ (Ω/□) or more and 10¹⁰ (Ω/□) or less.

A driving system of the liquid crystal is only required to be a horizontal electric field driving system and is not limited to the IPS system. Additionally, liquid crystal molecules may be negative liquid crystal molecules. When the liquid crystal molecules are positive liquid crystal molecules, the liquid crystal molecules fluctuate so as to be vertically aligned by a vertical electric field, whereas when the liquid crystal molecules are negative liquid crystal molecules, the liquid crystal molecules fluctuate so as to rotate, so that display abnormality when the vertical field is applied is reduced compared to the case of the positive liquid crystal molecules. Therefore, the negative liquid crystal molecules are more desirable than the positive liquid crystal molecules.

Note that, the display device with a touch sensor in the present embodiment is used for various electric equipment such as a mobile phone (including a smart phone or the like), a notebook computer (including a tablet computer or the like), a mobile information terminal (including an electronic book, a PDA, or the like), a digital photo frame, and a portable game machine.

### REFERENCE SIGNS LIST

11 CF substrate
12 array substrate
13 liquid crystal layer
14 touch drive electrodes
15 touch detection electrodes
16 dummy electrodes
17 polarizing plate
171 hard coat layer
172 polarizer
173 conductive layer
174 adhesive layer
175 conductive layer (adhesive layer)

1. A liquid crystal display device with a touch sensor, comprising:
a first substrate;
a second substrate that is opposite to the first substrate;
a liquid crystal layer interposed between the first substrate and the second substrate;
a touch sensor that includes a plurality of touch drive electrodes and a plurality of touch detection electrodes that are arranged such that at least one electrode of the touch drive electrodes and the touch detection electrodes is disposed on a first surface of the first substrate, which is opposite to the liquid crystal layer;
dummy electrodes disposed in a region where neither the touch drive electrodes nor the touch detection electrodes are disposed on the first surface of the first substrate; and
a polarizing plate that is disposed on electrodes, which are arranged on the first surface of the first substrate, of the touch drive electrodes and the touch detection electrodes and that includes a conductive layer having a surface resistance of 10⁹ (Ω/□) or more and 10¹⁰ (Ω/□) or less.

2. The liquid crystal display device with a touch sensor according to claim 1, wherein the polarizing plate includes: a polarizer; the conductive layer having a surface resistance of 10⁹ (Ω/□) or more and 10¹⁰ (Ω/□) or less; and an adhesive layer for bonding the polarizing plate to the electrodes, which are arranged on the first surface of the first substrate, of the touch drive electrodes and the touch detection electrodes.

3. The liquid crystal display device with a touch sensor according to claim 1, wherein the polarizing plate includes a polarizer and the conductive layer having a surface resistance of 10⁹ (Ω/□) or more and 10¹⁰ (Ω/□) or less, and the conductive layer includes an adhesive member for bonding the polarizing plate to the electrodes, which are arranged on the first surface of the first substrate, of the touch drive electrodes and the touch detection electrodes.

4. The liquid crystal display device with a touch sensor according to claim 1, wherein the touch drive electrodes and the touch detection electrodes are disposed on the first surface of the first substrate.

5. The liquid crystal display device with a touch sensor according to claim 1, wherein
the touch detection electrodes are disposed on the first surface of the first substrate, and
the touch drive electrodes are disposed between the first substrate and the second substrate.
